(19) United States
(12) Patent Application Publication
(10) Pub. No.: US 2026/0218035 A1
(43) Pub. Date: Jul. 30, 2026

(54) FLUID LOSS CONTROL FOR GEOPOLYMER SYSTEM

(71) Applicant: Schlumberger Technology Corporation, Sugar Land, TX (US)

(72) Inventors: Xia WEI, Sugar Land, TX (US); Yeukayi NENJERAMA, Sugar Land, TX (US); Valerie Gisele Helene LAFITTE, Sugar Land, TX (US); Mark MEADE, Sugar Land, TX (US); Dean Michael WILLBERG, Sugar Land, TX (US); Saurabh KAPOOR, Houston, TX (US); Bipin JAN, Sugar Land, TX (US); Shameed ASHRAF, Kuala Lumpur (MY)

(21) Appl. No.: 19/143,924

(22) PCT Filed: Mar. 14, 2024
(86) PCT No.: PCT/US2024/019972

§ 371 Date: Jun. 27, 2025

Related U.S. Application Data
(60) Provisional application No. 63/452,082, filed on Mar. 14, 2023.

(51) Int. Cl. C09K 8/487; C04B 14/10; C04B 14/28; C04B 24/16; C04B 24/26; C04B 24/38; C04B 28/00; C04B 40/00; C04B 103/00; C04B 103/40; C04B 111/00; C09K 8/508; C09K 8/514; E21B 33/138

(52) U.S. Cl. CPC C09K 8/487; C04B 14/104; C04B 14/28; C04B 24/166; C04B 24/2641; C04B 24/2676; C04B 24/383; C04B 28/006; C04B 40/0039; C09K 8/5083; C09K 8/514; E21B 33/138; C04B 2103/0053; C04B 2103/0054; C04B 2103/408; C04B 2111/00146

(57) ABSTRACT

Methods of cementing a subterranean well using a geopolymer composition are provided herein. In one aspect, the geopolymer composition can be a pumpable mixture comprising an aluminosilicate source, an activator, a carrier fluid, and a fluid loss composition comprising at least two materials selected from the group consisting of a water soluble polymer, a polymer particle dispersion, a particulate additive, and a dispersant. The geopolymer composition is placed in the subterranean well and allowed to harden into a solid geopolymer. Other methods herein include preparing a dry geopolymer slurry precursor comprising an aluminosilicate source, a metal silicate, an activator, a fluid loss control agent, and a fluid loss control agent enhancer; mixing the dry geopolymer slurry precursor with water to form a pumpable geopolymer precursor; pumping the geopolymer precursor into a subterranean well; and hardening the geopolymer precursor into a solid geopolymer within the subterranean well.

### CROSS-REFERENCE TO RELATED APPLICATIONS

This patent application claims benefit of U.S. Provisional Patent Application Ser. No. 63/452,082 filed Mar. 14, 2023, which is entirely incorporated herein by reference.

### FIELD

This patent application relates to cement compositions and methods of applying cement compositions in wells. Specifically, this patent application addresses fluid loss in cement slurries and methods of managing fluid loss in cement slurries.

### BACKGROUND

Geopolymers are a novel class of materials that are formed by chemical dissolution and subsequent recondensation of various aluminosilicate oxides and silicates to form an amorphous three-dimensional poly(silicon-oxo-aluminate) framework structure with empirical formula Mₙ{-(SiO₂)_{z}—AlO₂}ₙ, w H₂O, where M is a cation such as potassium, sodium or calcium, n is a degree of polymerization and z is the Si/Al atomic ratio that may be 1, 2, 3 or more.

The properties and application fields of geopolymers depend principally on their chemical structure, and more particularly on the Si/Al molar ratio. Geopolymers have been investigated for use in several applications, including as concrete systems within the construction industry, as refractory materials and as encapsulants for hazardous and radioactive waste streams. Geopolymers are recognized as being rapid setting and hardening materials that provide superior hardness and chemical stability, and represent an alternative to conventional cements for use in demanding applications.

Geopolymer synthesis involves the suspension of solid raw materials, such as the above mentioned aluminosilicates, into a carrier fluid to form a slurry. The fluid-to-solid ratio of this slurry affects properties of the slurry such as, for example, its viscosity and hardening time, and the properties of the hardened material obtained from the same slurry. The solid materials of the slurry generally have particle size that is smaller than conventional cement materials, and fluid loss can be an important factor in geopolymer slurries. In subterranean applications, the slurry can frequently come into direct contact with a geologic formation, and the carrier fluid of the slurry may escape into the formation. Uncontrolled fluid loss may result in a slurry density increase and a deviation from the original slurry design. If sufficient fluid is lost into the formation, primary cementing failures may occur. Methods and compositions are needed to manage and mitigate fluid loss in geopolymer slurries without adversely impacting other properties, such as density and hardening, which make geopolymer compositions attractive.

### SUMMARY

Embodiments described herein provide methods, comprising preparing a pumpable geopolymer precursor comprising an aluminosilicate source, an activator, a carrier fluid, and a fluid loss control composition comprising at least two materials selected from the group consisting of a water soluble polymer, a polymer particle dispersion, a particulate additive, and a dispersant; placing the geopolymer precursor in a subterranean well; and hardening the geopolymer precursor into a solid geopolymer.

Other embodiments described herein provide methods that comprise preparing a dry geopolymer slurry precursor comprising an aluminosilicate source, a metal silicate, an activator, a fluid loss control agent, and a fluid loss control agent enhancer; mixing the dry geopolymer slurry precursor with water to form a pumpable geopolymer precursor; pumping the geopolymer precursor into a subterranean well; and hardening the geopolymer precursor into a solid geopolymer within the subterranean well.

Other embodiments described herein provide a dry geopolymer slurry precursor, comprising an aluminosilicate source, an activator, a fluid loss control agent, and a fluid loss control agent enhancer.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Geopolymer materials use an aluminosilicate source and an alkali activator in an aqueous solution having high pH to form the polymer described above. Examples of aluminosilicate sources that can be used include (but are not limited to) ASTM type C fly ash, ASTM type F fly ash, fly ash not classified by ASTM, volcanic ash, ground blast furnace slag, calcined clays, which may be partially or fully calcined clays (metakaolin is a partially calcined clay), aluminum-containing silica fume, natural aluminosilicate, synthetic aluminosilicate glass powder, zeolite, scoria, allophone, bentonite, red mud, which may be calcined, and pumice. These materials contain a significant proportion of an amorphous aluminosilicate phase, which reacts in strong alkaline solutions. The more common aluminosilicates are fly ash, metakaolin and blast furnace slag. Mixtures of two or more aluminosilicate sources may also be used if desired. In addition, alumina and silica may be added separately, for example as a blend of bauxite and silica fume.

Formation of the set geopolymer also involves an alkali activator. The alkali activator may be an alkali metal, an alkaline-earth metal hydroxide, or combinations thereof. Alkali metal hydroxides may be sodium, lithium, or potassium hydroxide. Alkaline-earth metal hydroxides may include calcium, barium, or magnesium hydroxide. Mixtures of alkali metal hydroxides, alkaline earth metal hydroxides, and mixtures of both alkali metal and alkaline earth metal hydroxides can be used. The metal hydroxide may be in the form of a solid or an aqueous mixture. Also, the activator in another embodiment can be encapsulated. The activator when in solid and/or liquid state can be trapped in a capsule that will break when subjected to, for example, mechanical stress on the capsule, or coating degradation owing to temperature, chemical exposure or radiation exposure. Also, the activator when in solid and/or liquid state can be trapped in a capsule that will naturally degrade if made from a biodegradable or self-destructive material. Furthermore, the alkali activator when in liquid state may be adsorbed into a porous material and may be released after a certain time or due to a predefined event. The alkali activator may be present in the composition at a concentration between about 0.1 moles/L (M) to 10M or between 3M and 6M.

The aluminosilicate source and activator are mixed together to form a precursor, and the precursor is deployed to an application to harden into a geopolymer. As mentioned above, where the precursor is deployed to a subterranean application, the precursor can come into contact with a geologic formation that can facilitate fluid loss from the precursor. The small particle size of solids in a geopolymer slurry, in some cases as small as 5-20 μm, can lead to increased fluid loss. It has been discovered that certain materials can be added to the precursor to reduce fluid loss from the precursor. A water soluble or water-dispersible polymer can be used to agglomerate the particles in the precursor, leading to larger solid bodies that can slow fluid loss. A dispersant can be used to disperse particles within the precursor to optimize plugging of fluid flow pores. In general, it has been found that using two of the three components above in a geopolymer slurry results in reduced fluid loss.

Thus, a geopolymer precursor having reduced fluid loss comprises an aluminosilicate source, an activator, and a fluid loss control composition comprising at least two materials selected from the group consisting of a water soluble polymer, a polymer particle dispersion, a dispersant, and a particle additive other than the aluminosilicate source. A combination of a water soluble polymer and a polymer particle dispersion can be used as a fluid loss control composition for a geopolymer precursor. Likewise, any of a water soluble polymer and a dispersant, a water soluble polymer and a particle additive, a dispersant and a particulate additive, a dispersant and a polymer particle dispersion, or a polymer particle dispersion and a particle additive can be used as a fluid loss control composition. Three of the components listed above, or all four, can be used as a fluid loss control composition for a geopolymer precursor. Examples of polymers that can be used include polyvinyl alcohol, polyvinyl amine, polysaccharide and other carbohydrates, and esters thereof, poly(meth)acrylic acid, polyethylene imine, polyethylene glycol, polyether, polymaleic acid, acrylamidomethylpropane sulfonic acid/acrylamide copolymer, vinyl acetal polymer, vinylamide/vinylsulfonated copolymer, starch, and combinations and derivatives thereof. Latexes such as polystyrene latex and polystyrene-butadiene latex can also be used. The aforementioned polymers can be used as oligomers in most cases. Polynaphthalene sulfonate, polymelamine sulfonate, polycarboxylate, and sulfonated polyamide dispersants can be used. Bentonite, wood cellulose, ground walnut shells, calcium carbonate, mica, and polyester synthetic fibers can be used as particle additives.

The polymer materials described above can be particles in a polymer particle dispersion material, such as a latex material. The latex material typically includes at least some water in the liquid bulk phase of the latex material. Other liquid materials, such as organic solvents, which may be miscible or immiscible with water to any suitable extent, can be included. The latex material includes polymer particles dispersed in the liquid bulk phase. The polymer particles can have any suitable particle size distribution, which can be selected to enhance dispersibility in the liquid bulk phase of the latex, to enhance dispersibility in the geopolymer precursor, to enhance fluid loss control, or any combination thereof. For example, the polymer particles can have a particle size distribution with mode, average, or D50 that is selected based on flow characteristics of a formation into which the geopolymer precursor is to be deployed. The polymer particles can also be selected to have water reactivity, such as swelling or viscosity enhancement, that results in fluid loss control when the geopolymer precursor is deployed to a target location. The latex material may also include low molecular weight polymer materials, which may be liquid or gel-like materials. The low molecular weight polymer materials can enhance the fluid loss control performance of the polymer particles by interacting with the polymer particles, for example by dissolving or partially dissolving, adhering or partially adhering, agglomerating or partially agglomerating, and/or dispersing or partially dispersing the polymer particles.

The particle additive may be, or may include, a material that controls fluid loss to some extent on its own, or the particle additive may be, or may include, a material that has no fluid loss control functionality of its own but nonetheless enhances fluid loss control performance of another fluid loss agent. The particle additive may be, or may include, a material that changes or responds in some way when exposed to, or immersed in, water (for example by swelling, partially dissolving, etc.), or the particle additive may be, or may include, a material that is unresponsive to water.

Dispersants can be used in quantities of 0.1 to 1% by weight of the dry blend. Particulates can be included in quantities of 1 to 5% by weight of the dry blend. Latex polymers can be included in quantities of 1 to 5% by weight of the dry blend. Water soluble polymers can be used in quantities of 0.5 to 3% by weight of the dry blend. Combinations of latex and water soluble polymers can be used, with total polymer content selected to maintain pumpability of the slurry formed by mixing the liquid and dry ingredients. Depending on factors like slurry density, solids content, and temperature, a pumpable slurry can be obtained using up to 10% total polymer by weight of dry blend in some cases, while other cases might be limited to 5% or less total polymer by weight of dry blend to maintain a pumpable slurry.

In other cases, fluid loss can be reduced by including in the precursor a fluid loss control agent and a fluid loss control agent enhancer. The fluid loss control agent generally has fluid loss control functionality, reducing fluid loss in a geopolymer precursor by some amount. The fluid loss control agent enhancer generally improves performance of the fluid loss control agent at reducing fluid loss. The fluid loss control agent enhancer may have fluid loss control functionality by itself, or the fluid loss control agent enhancer might have no fluid loss control functionality by itself. The fluid loss control agent enhancer may respond to water in various ways, for example by swelling or partially or completely dissolving, or the fluid loss control agent enhancer might exhibit no response to water. As described above, at least two fluid loss control agents can be combined in a geopolymer slurry, such that at least one of the fluid loss control agents is a fluid loss control agent enhancer.

A The fluid loss control agents and enhancers described herein can be mixed with other dry ingredients to form a geopolymer slurry precursor that is a dry solid. Liquid ingredients including water can be added to the precursor to make a pumpable geopolymer precursor that can be deployed in a subterranean well. In some cases, a dry geopolymer slurry precursor can be formed, including the fluid loss additives described herein, to which only water is added to make a pumpable geopolymer precursor. In such cases, an alkali metal salt is combined, as a solid material, with an alkaline earth metal hydroxide, also as a solid material, in the dry geopolymer slurry precursor with the aluminosilicate source and other ingredients, such as the fluid loss control agents and enhancers described herein. Solid activator materials that can be used for such purposes include lime, hydrated lime, cement kiln dust, soda ash, sodium silicate, soda-lime glass dust, borosilicate glass dust, cement by-pass dust, or combinations thereof. Aluminosilicate sources that can be used include fly ashes such as ASTM type C fly ash, ASTM type F fly ash, and fly ashes not classified by ASTM, volcanic ash, ground blast furnace slag, calcined or partially calcined clays (such as metakaolin), aluminum-containing silica fume, natural aluminosilicate, synthetic aluminosilicate glass powder, zeolite, scoria, allophone, bentonite, red mud, which may be calcined, and pumice. Mixtures of two or more aluminosilicate sources may also be used if desired. In addition, alumina and silica may be added separately, for example as a blend of bauxite and silica fume.

Other additives that can be used in the formulations described herein include retarders, accelerants, density modifiers, antifoam agents, defoamers, silica, viscosifiers, dispersants, expanding agents, and anti-settling additives can also be used. Some or all of such additives can be included as dry ingredients in the dry geopolymer slurry precursor mixture to which only water is added to make a geopolymer precursor. Such additives can also be added to the liquid phase prior to forming the geopolymer precursor. Retarders that can be used include sodium pentaborate decahydrate, borax, boric acid, lignosulphonates, sodium glucoheptonate, tartaric acid, citric acid, or phosphorus containing compounds such as phosphoric acid, and salts thereof. Lithium salts can be used as accelerant. Density modifiers are typically particles of selected density that increase or decrease slurry density. Materials such as hollow glass or ceramic microspheres (cenospheres), plastic particles such as polypropylene beads, rubber particles, uintaite (sold as GILSONITE™), vitrified shale, and petroleum coke or coal can be used as density modifiers. Viscosifiers that can be used include diutan gum, polysaccharide biopolymers, which can include whelan gum, polyanionic cellulose, and carboxymethylcellulose. Carboxylic acids including gluconic acid, glucoheptonic acid, tartaric acid, citric acid, glycolic acid, lactic acid, formic acid, acetic acid, proprionic acid, oxalic acid, malonic acid, succinic acid, adipic acid, malic acid, nicotinic acid, benzoic acid and ethylenediamine tetraacetic acid (EDTA) may be included in the compositions as retarders or dispersants or both. Phosphoric acids may be present for the same purpose. Salts of these acids may also be employed. Expanding agents that can be used include calcium sulfate hemihydrate, metal oxides such as MgO or combinations thereof.

The fluid loss control agents and enhancers described herein can be added to dry ingredients that form a dry mixture for a geopolymer precursor, including the aluminosilicate source and any other dry ingredients, such as other silicates, retarding agents, accelerating agents, density modifiers, rheology modifiers, thickeners, anti-foaming agents, defoamers, expanders, and the like that may be added in solid form. The fluid loss control agents and enhancers described herein can also be added to liquid ingredients that are combined with the dry mixture to form the geopolymer precursor. The fluid loss control agents and enhancers can be added to both the dry ingredients and the liquid ingredients.

The methods presented in this disclosure are applicable to the oilfield, for example during completion of the wellbore of oil or gas wells. To be used in oilfield applications, a pumpable slurry is formed where the geopolymer blend is mixed with a carrier fluid. A geopolymer precursor is generally considered pumpable where the precursor has a consistency lower than about 70 Bc (Bearden consistency units) as measured by a high-temperature, high-pressure consistometer, a yield value (Ty) lower than about 50 lbf/100 ft², or both. before subterranean uses, the geopolymer precursor is generally formulated at the surface and pumped into the wellbore. The precursor is then allowed to set and harden in the well to provide zonal isolation in the wellbore.

The geopolymer precursor comprising at least two of a water soluble polymer, a polymer particle dispersion, a dispersant, and a particle additive is prepared and pumped into a well that contains a pipe. Typically, the geopolymer precursor is pumped down the interior of the pipe to the bottom of the well and back up in the annular region between the pipe exterior and the well wall. The precursor is allowed to set between the pipe exterior and the well wall, forming a hard lining for the well that isolates the well interior from the formation, and prevents uncontrolled flow of fluids from the formation into the well interior. The fluid loss control agents and enhancers described herein reduce or prevent flow of liquids from the precursor into the formation before the slurry hardens, and have little or no effect on rheology of the geopolymer precursor.

Geopolymer precursors containing fluid loss control compositions conforming to the description herein were tested for fluid loss following API procedure RP 10B-2 at 160° F. and 1000 psi to simulate subterranean performance. For each example precursor below, aluminosilicate source, a first activator, a second activator, and a retarder were used at 100 parts, 8 parts, 5 parts, and 1.1 parts by weight to a density of 14.8 pounds per gallon. Polymer “Pr1” is an acrylate polymer, polymer “Pr2” is a polystyrene-butadiene latex polymer, and the particulates are particulates that do not participate in a geopolymerization reaction, but that respond to water in various ways. Particulate “P1” is Bentonite, particulate “P2” is cellulose, and particulate “P3” is calcium carbonate. The dispersant is a polynaphthalene sulfonate. Table 1 shows fluid loss control agents and enhancers included in each example mixture (in parts per part aluminosilicate), and milliliters of fluid loss in 30 minutes.

TABLE 1

| | | | | | | | API Fluid |
|---|---|---|---|---|---|---|---|
| Example | Pr1 | Pr2 | P1 | P2 | P3 | Dispersant | Loss (ml) |
| 1 | | 2.5 | | | | 0.1 | 46 |
| 2 | | 2.5 | | 0.7 | | 0.1 | 31 |
| 3 | | 2.2 | | 0.7 | | 0.1 | 54 |
| 4 | | 2.0 | | 0.7 | | 0.1 | 86 |
| 5 | | 2.0 | | | 0.7 | 0.1 | 50 |
| 6 | | 2 | 4 | | | | 64 |
| 7 | 2.5 | | | 0.7 | | 0.1 | 82 |
| 8 | 1.5 | | 5 | | | | 83 |

In example 9, aluminosilicate source, a first activator, a second activator, viscosifier, and a retarder were used at 100 parts, 8 parts, 5 parts, 0.05 parts, and 1.1 parts by weight to a density of 14.8 pounds per gallon. Polystyrene-butadiene latex and a polynaphthalene sulfonate dispersant are used as a fluid loss control composition. Table 2 shows the rheology of the resulting precursor and Table 3 indicates the milliliters of fluid loss in 30 minutes.

TABLE 2
Rheology of Example 9

| | Surface (r.t.) | | Downhole (170° F.) | |
|---|---|---|---|---|
| RPM | Up | Down | Up | Down |
| 300 | 77 | 77 | 90 | 90 |
| 200 | 57 | 58 | 71 | 66 |
| 100 | 40 | 36 | 45 | 41 |
| 60 | 30 | 27 | 34 | 30 |
| 30 | 22 | 19 | 23 | 21 |
| 6 | 13 | 11 | 12 | 11 |
| 3 | 11 | 10 | 10 | 10 |

| | | |
|---|---|---|
| 10 sec gel | 11 deg-12 lbf/100 ft² | 11 deg-12 lbf/100 ft² |
| 10 min gel | 29 deg-31 lbf/100 ft² | 20 deg-21 lbf/100 ft² |
| PV, cP | 66 cP | 80 cP |
| Ty, lbf/100 ft² | 13 lbf/100 ft² | 13 lbf/100 ft² |

TABLE 3
Fluid loss of Example 9

| | Fluid loss |
|---|---|
| Time | volume (ml) |
| 0.5 min | 9 |
| 1 min | 13 |
| 5 min | 23 |
| 10 min | 28 |
| 15 min | 31 |
| 20 min | 33 |
| 30 min | 34 |
| API Fluid | 68 |
| Loss (ml) | |

In Examples 10 and 11, aluminosilicate source, a first activator, a second activator, accelerator, viscosifier, and a retarder were used at 100 parts, 8 parts, 12 parts, 2 parts, 0.1 parts, and 0.5 parts by weight to a density of 13.2 pounds per gallon. Definitions of the polymers and particulates are as above, and the dispersant is a polynaphthalene sulfonate. Tables 5-8 show rheology and fluid loss of the precursors corresponding to Examples 10 and 11.

TABLE 4

| | | | | | | API Fluid |
|---|---|---|---|---|---|---|
| Example | Pr1 | Pr2 | P1 | P2 | Dispersant | Loss (ml) |
| 10 | | 2.5 | | 0.7 | 0.1 | 130 |
| 11 | 1.5 | | 5 | | 0.1 | 143 |

TABLE 5
Rheology of Example 10

| | Surface (r.t.) | | Downhole (170° F.) | |
|---|---|---|---|---|
| RPM | Up | Down | Up | Down |
| 300 | 70 | 70 | 68 | 68 |
| 200 | 55 | 55 | 56 | 55 |
| 100 | 38 | 35 | 40 | 36 |
| 60 | 30 | 26 | 31 | 29 |
| 30 | 21 | 19 | 24 | 21 |
| 6 | 13 | 11 | 14 | 12 |
| 3 | 12 | 10 | 12 | 10 |

| | | |
|---|---|---|
| 10 sec gel | 13 deg-14 lbf/100 ft² | 11 deg-12 lbf/100 ft² |
| 10 min gel | 30 deg-32 lbf/100 ft² | 26 deg-28 lbf/100 ft² |
| PV, cP | 59 cP | 56 cP |
| Ty, lbf/100 ft² | 13 lbf/100 ft² | 15 lbf/100 ft² |

TABLE 6
Fluid loss of Example 10

| | Fluid loss |
|---|---|
| Time | volume (ml) |
| 0.5 min | 10 |
| 1 min | 13 |
| 5 min | 27 |
| 10 min | 38 |
| 15 min | 47 |
| 20 min | 53 |
| 30 min | 65 |
| API Fluid | 130 |
| Loss (ml) | |

TABLE 7
Rheology of Example 11

| | Surface (r.t.) | | Downhole (170° F.) | |
|---|---|---|---|---|
| RPM | Up | Down | Up | Down |
| 300 | 56 | 56 | 33 | 33 |
| 200 | 40 | 41 | 27 | 24 |
| 100 | 25 | 24 | 17 | 15 |
| 60 | 20 | 17 | 12 | 11 |
| 30 | 15 | 12 | 10 | 8 |
| 6 | 8 | 7 | 6 | 6 |
| 3 | 7 | 6 | 5 | 5 |

| | | |
|---|---|---|
| 10 sec gel | 8 deg-9 lbf/100 ft² | 7 deg-7 lbf/100 ft² |
| 10 min gel | 18 deg-19 lbf/100 ft² | 13 deg-14 lbf/100 ft² |
| PV, cP | 49 cP | 28 cP |
| Ty, lbf/100 ft² | 7 lbf/100 ft² | 6 lbf/100 ft² |

TABLE 8
Fluid loss of Example 11

| | Fluid loss |
|---|---|
| Time | volume (ml) |
| 0.5 min | 9.5 |
| 1 min | 13 |
| 5 min | 28 |
| 10 min | 40 |
| 15 min | 49 |
| 20 min | 57 |
| 30 min | Blowout @ |
| | 26 min, 66.5 ml |
| API Fluid | 143 |
| Loss (ml) | |

Tables 9 and 10 show how a fluid loss control agent enhancer that has no fluid loss control functionality by itself can be used, with a fluid loss control agent, to enhance performance of the fluid loss control agent in a fluid loss control composition. Table 9 shows two examples, Examples 12 and 13, of a geopolymer precursor that contains two fluid loss control agents, a latex material and a cellulose material, as a fluid loss control composition. Example 13 contains about 25% of the amount of the latex material as in Example 12, with all other ingredients the same in the same amounts. The fluid loss results of the two precursors demonstrates that reducing the latex material by a large amount, in the fluid loss control composition, reduced the fluid loss control performance of the geopolymer precursor markedly.

TABLE 9
Latex Effect on Fluid Loss
Control in Geopolymer Precursor

| Example | 12 | 13 |
|---|---|---|
| Solid Volume Fraction % | 40 | 39.6 |
| Density, lb/gal | 15 | 15 |
| Bottom Hole Circulation | 55 | 55 |
| Temperature, ° C. | | |
| Bottom Hole Pressure | 3100 | 3100 |
| (BHP), psi | | |
| Time to BHP, min | 60 | 60 |
| Fly Ash TG Bin, g | 637 | 641.33 |
| 50% NaOH soln., g | 122 | 121.38 |
| Sodium Silicate, g | 76 | 75.99 |
| Sea water, g | 157 | 214.64 |
| Antifoam, g | 1 | 1 |
| Latex, g | 84 | 20.98 |
| Cellulose source, g | 3 | 3 |
| API Fluid Loss, mL | 26 | 177 |

Table 10 shows four additional examples, Examples 14-17, of geopolymer precursors that contain fluid loss control compositions that have a fluid loss control agent enhancer in the form of a particle additive that does not respond to water. This particle additive is a cellulose material that has a particle size distribution selected to enhance fluid loss control performance of a fluid loss control agent. The particle additive used in these examples has a particle size distribution with D50 of about 40 μm to about 60 μm. Example 12 from Table 9 is reproduced in Table 10 for reference.

TABLE 10
Effect of Enhancement on Fluid Loss
Control in Geopolymer Precursor

| Example | 12 | 14 | 15 | 16 | 17 | 18 |
|---|---|---|---|---|---|---|
| Solid Volume | 40 | 39.5 | 39.7 | 39.7 | 39.7 | 51.4 |
| Fraction % | | | | | | |
| Density, lb/gal | 15 | 15 | 15 | 15 | 14 | 14.6 |
| Bottom Hole | 55 | 55 | 55 | 55 | 55 | 40 |
| Circulation | | | | | | |
| Temp., ° C. | | | | | | |
| Bottom Hole | 3100 | 3100 | 3100 | 3100 | 3100 | 1600 |
| Pressure | | | | | | |
| (BHP), psi | | | | | | |
| Time to BHP, | 60 | 60 | 60 | 60 | 60 | |
| min | | | | | | |
| Fly Ash, g | 637 | 633.57 | 636.55 | 638.04 | 521.99 | |
| GGBS, g | | | | | | 596.0 |
| 50% NaOH | 122 | 120.75 | 121.32 | 121.61 | 121.06 | |
| soln., g | | | | | | |
| Sodium | 76 | 75.07 | 75.42 | 75.6 | 75.38 | |
| Silicate, g | | | | | | |
| Sodium | | | | | | 44.7 |
| carbonate, g | | | | | | |
| Lime, g | | | | | | 5.96 |
| Sea water, g | 157 | 156.09 | 193.22 | 211.78 | 236.15 | |
| Fresh water, g | | | | | | 94.23 |
| Antifoam, g | 1 | 1 | 1 | 1 | 1 | 1.1 |
| Dispersant, g | 0 | 0 | 0 | 0 | 0 | 2.98 |
| Latex, g | 84 | 82.53 | 41.46 | 20.93 | 41.19 | 304.6 |
| Particle | 3 | 5 | 5 | 5 | 5 | 0 |
| Additive, | | | | | | |
| lb/bbl | | | | | | |
| API Fluid | 26 | 10 | 10 | 26 | 20 | 2 |
| Loss, mL | | | | | | |

Examples 14-16 show decreasing amounts of the latex material, similar to what is shown in Table 9. Example 17 shows performance in a lower density precursor material using an amount of latex similar to the amount in Example 15. The mass of fluid loss control agent enhancer in each case was 9.44 g. Although amount of the fluid loss control agent, the latex material, is reduced, use of the fluid loss control agent enhancer in the fluid loss control compositions of Examples 14-17 maintains fluid loss control performance of the latex material as quantity of the latex material declines. While the fluid loss control agent enhancer of Examples 14-17 has no fluid loss functionality on its own, comparing Example 16 with Example 13 shows the fluid loss control enhancement functionality of the particle additive. Comparing Examples 13-17 with Examples 12 and 13 also shows that the cellulose source, which contains water reactive particles, does not perform a fluid loss control enhancement function, at least to the extent of the particle blend used in Examples 14-17.

Examples 14-17 also show that using a fluid loss control agent enhancer can sharply reduce the amount of fluid loss control agent needed to control fluid loss in a geopolymer precursor. In Example 12, the quantity of fluid loss control agent (summing the latex and the cellulose source) is about 13.7% of the amount of aluminosilicate source in the geopolymer precursor. In Example 16, the quantity of fluid loss control agent is about 3.3% of the amount of aluminosilicate source in the geopolymer precursor. Thus, using a fluid loss control agent enhancer reduced the amount of fluid loss control agent needed to control fluid loss by about 75%. The examples shown in Tables 1 and 4 have similar quantities of fluid loss control agents in them, showing similar performance to the examples of Table 10. In each case, the amount of fluid loss control agent is less than about 4% of the amount of aluminosilicate source in the geopolymer precursor, and the amount of fluid loss control agent enhancer is generally about 5% of less of the amount of aluminosilicate source in the geopolymer precursor, such as about 2% or less, for example about 1% or less.

Example 18 shows a geopolymer precursor that uses a latex material and a dispersant in a fluid loss control composition. Example 18 is consistent with other results herein that show use of a fluid loss control composition comprising at least two materials selected from the group consisting of a water soluble polymer, a polymer particle dispersion, a dispersant, and a particle additive, where the particle additive can be unresponsive to water.

Formulations of geopolymer precursors that include fluid loss control are shown in Table 11. In the formulations of Table 11, the aluminosilicate source is fly ash, GGBS, metakaolin, or a combination thereof. The fluid loss control agent in Table 11 is latex, polyacrylic, or a combination thereof. The fluid loss control agent enhancer in Table 11 is cellulose, silica, or Bentonite particles, or a combination thereof. The dispersant in Table 11 is polynaphthalene sulfonate.

TABLE 11
Geopolymer Formulations Having Fluid Loss Control

| Formulation | 1 | 2 | 3 | 4 |
|---|---|---|---|---|
| Aluminosilicate Source, % BVOB | 100 | 100 | 100 | 100 |
| Alkali metal carbonate, % BWOB | 20 | 20 | 10 | 10 |
| Calcium hydroxide, % BWOB | 15 | 15 | | |
| Alkali metal hydroxide, gal/sack | | | 10 | 10 |
| Fluid loss control agent, % BWOB | 3 | 5 | 3 | 5 |
| Fluid loss control agent enhancer, | 10 | | 10 | |
| % BWOB | | | | |
| Dispersant, % BWOB | 2 | 2 | 2 | 2 |
| Retarder, % BWOB | 2 | 2 | 2 | 2 |
| Viscosifier, % BWOB | 0.5 | 0.5 | 0.5 | 0.5 |
| Antifoam, % BWOB | 0.1 | 0.1 | 0.1 | 0.1 |

These formulations have 3-5% fluid loss control agent, BWOB, and 2-10% enhancer, BWOB, (as dispersant or other enhancer), demonstrating that geopolymer precursors having a fluid loss control agent in an amount up to 5% BWOB and a fluid loss control agent enhancer in an amount up to 10% BWOB exhibit good fluid loss control. Variations in the amounts of these formulations can also exhibit fluid loss control, so long as the amount of fluid loss control agent and fluid loss control agent enhancer, and optionally dispersant, is sufficient to provide fluid loss control to the formulation.

The preceding description has presented embodiments and examples of a technology subject matter. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown therein, but rather should be read as consistent with and as support for the following claims, which are to have their fullest and fairest scope.

1. A method, comprising:
preparing a pumpable geopolymer precursor comprising an aluminosilicate source, an activator, a carrier fluid, and a fluid loss control composition comprising at least two materials selected from the group consisting of a water soluble polymer, a polymer particle dispersion, a particulate additive, and a dispersant;
placing the geopolymer precursor in a subterranean well; and
hardening the geopolymer precursor into a solid geopolymer.

2. The method of claim 1, wherein the fluid loss control composition comprises a water soluble polymer, wherein the water soluble polymer is selected from the group consisting of polyvinyl alcohol, polyvinyl amine, polysaccharide and esters thereof, poly(meth)acrylic acid, polyethylene imine, polyethylene glycol, polyether, polymaleic acid, acrylamidomethylpropane sulfonic acid/acrylamide copolymer, vinyl acetal polymer, vinylamide/vinylsulfonated copolymer, starch, or a combination or derivative thereof.

3. The method of claim 1, wherein the fluid loss control composition comprises a polymer particle dispersion, wherein the polymer particle dispersion is a polystyrene latex, a polystyrene-butadiene latex, or a combination thereof.

4. The method of claim 1, wherein the fluid loss control composition comprises a particle additive, wherein the particle additive is selected from the group consisting of Bentonite, wood cellulose, ground walnut shells, calcium carbonate, mica, polyester synthetic fibers, or a combination thereof is used as a fluid loss agent.

5. The method of claim 1, wherein the fluid loss control composition comprises a dispersant, wherein the dispersant is selected from the group consisting of polynaphthalene sulfonate, polymelamine sulfonate, polycarboxylate, sulfonated polyamide, or a combination thereof.

6. The method of claim 1, wherein the fluid loss control composition comprises a polymer particle dispersion and a dispersant.

7. A method, comprising:
preparing a dry geopolymer slurry precursor comprising an aluminosilicate source, a metal silicate, an activator, a fluid loss control agent, and a fluid loss control agent enhancer;
mixing the dry geopolymer slurry precursor with water to form a pumpable geopolymer precursor;
pumping the geopolymer precursor into a subterranean well; and
hardening the geopolymer precursor into a solid geopolymer within the subterranean well.

8. The method of claim 7, wherein the fluid loss control agent enhancer is a particle additive having a particle size distribution selected based on a flow characteristic of the formation into which the well is drilled.

9. The method of claim 8, wherein the fluid loss control agent enhancer has a D50 that is between about 40 μm and about 60 μm.

10. The method of claim 9, wherein the fluid loss control agent enhancer does not respond to water.

11. The method of claim 10, wherein the fluid loss control agent is a latex.

12. The method of claim 7, wherein the fluid loss control agent is a polymer particle dispersion and the fluid loss control agent enhancer is a dispersant.

13. A dry geopolymer slurry precursor, comprising:
an aluminosilicate source, an activator, a fluid loss control agent, and a fluid loss control agent enhancer.

14. The dry geopolymer slurry precursor of claim 13, wherein the fluid loss control agent comprises a polymer particle dispersion, the fluid loss control agent enhancer comprises a particle additive, the polymer particle dispersion is a polystyrene latex, a polystyrene-butadiene latex, or a combination thereof, and the particle additive has no response to water and has a D50 that is between about 40 μm and about 60 μm.

15. The dry geopolymer slurry precursor of claim 13, wherein the fluid loss control agent comprises a polymer particle dispersion and the fluid loss control agent enhancer comprises a dispersant.

16. The dry geopolymer slurry precursor of claim 13, wherein the fluid loss control agent is present in the dry geopolymer slurry precursor in an amount that is about 5% or less of an amount of the aluminosilicate source, and the fluid loss control agent enhancer is present in the dry geopolymer slurry precursor in an amount that is less than about 4% of the amount of the aluminosilicate source.

17. The dry geopolymer slurry precursor of claim 13, wherein the fluid loss control agent is present in the precursor at a concentration of up to 5%, by weight of the precursor blend, and the fluid loss control agent enhancer is present in the precursor at a concentration of up to 10%, by weight of the precursor blend.

18. The dry geopolymer slurry precursor of claim 16, further comprising a retarder, an accelerant, a density modifier, an antifoam agent, a defoamer, silica, a viscosifier, an expanding agent, an anti-settling additive, or a combination thereof.
